(19) United States
(12) Patent Application Publication
(10) Pub. No.: US 2018/0095286 A1
(43) Pub. Date: Apr. 5, 2018

(54) Apparatus and Method for Capturing Images

(71) Applicant: Nokla Technlogies Oy, Espoo (FI)

(72) Inventor: Lasse Laaksonen, Tampere (FI)

(21) Appl. No.: 15/563,780

(22) PCT Filed: Mar. 11, 2016
(86) PCT No.: PCT/FI2016/050148

§ 371 Date: Oct. 2, 2017

(30) Foreign Application Priority Data
Apr. 16, 2015 (GB) 1506434.8

(51) Int. Cl. G02B 27/10; G02B 27/14; H04N 5/225; H04N 5/232

(52) U.S. Cl. CPC G02B 27/108; G02B 27/144; H04N 5/23293; H04N 5/2254; H04N 5/2258; H04N 5/2253

(57) ABSTRACT

An apparatus and method wherein the apparatus: includes a first optical arrangement configured to provide a first image to an electronic viewfinder wherein the first optical arrangement includes a display component; a second optical arrangement configured to provide a second image to an optical viewfinder; a beam splitter configured to split a beam from the second optical arrangement; and an auxiliary image sensor configured to detect a beam from the beam splitter and obtain an image corresponding to the second image so that at least a portion of the second image can be compared to the first image.

### TECHNOLOGICAL FIELD

Examples of the present disclosure relate to an apparatus and method for capturing images. In particular, they relate to an apparatus and method for capturing images wherein the apparatus comprises an optical viewfinder and an electronic viewfinder or a hybrid viewfinder.

### BACKGROUND

Apparatus which comprise an optical viewfinder and an electronic viewfinder are known. In some apparatus the optical viewfinder and the electronic viewfinder may be combined into a hybrid viewfinder.

In such apparatus there may be differences between the image provided by the electronic viewfinder and the image provided by the optical viewfinder. The electronic viewfinder may provide a through the lens image while the optical viewfinder looks through an aperture adjacent to the lens and provides a non-through the lens image. In such examples the optical viewfinder has an inherent parallax and so will show a slightly different image to the image that is recorded by the image sensor and provided by the electronic viewfinder.

It is useful to provide an apparatus which can address the differences between the image provided by the electronic viewfinder and the image provided by the optical viewfinder.

### BRIEF SUMMARY

According to various, but not necessarily all, examples of the disclosure, there may be provided an apparatus comprising: a first optical arrangement configured to provide a first image to an electronic viewfinder wherein the first optical arrangement comprises a display component; a second optical arrangement configured to provide a second image to an optical viewfinder; a beam splitter configured to split a beam from the second optical arrangement; and an auxiliary image sensor configured to detect a beam from the beam splitter and obtain an image corresponding to the second image so that at least a portion of the second image can be compared to the first image.

In some examples the auxiliary image sensor may be configured to obtain a portion of the second image. In some examples the auxiliary image sensor may be configured to obtain a central portion of the second image.

In some examples the apparatus may further comprise image processing circuitry wherein the image processing circuitry may be configured to compare a first image captured by a main image sensor with a second image captured by the auxiliary image sensor and adjust the first image provided to the electronic viewfinder.

In some examples the apparatus may further comprise a plurality of beam splitters and a plurality of auxiliary image sensors.

In some examples the beam splitter may comprise a pellicle mirror.

In some examples the apparatus may further comprise one or more optical components configured to compensate for light lost by the beam splitter.

In some examples the first optical arrangement and the second optical arrangement may be configured so that at least a portion of the second image can be displayed overlaying the first image.

In some examples the first optical arrangement and the second optical arrangement may be configured so that the first image can be displayed adjacent to the second image.

In some examples there may be provided a digital camera comprising an apparatus as described above.

According to various, but not necessarily all, examples of the disclosure, there may be provided a method comprising: using a first optical arrangement to provide a first image to an electronic viewfinder wherein the first optical arrangement comprises a display component; using a second optical arrangement to provide a second image to an optical viewfinder; splitting a beam from the second optical arrangement; using an auxiliary image sensor to detect the beam from the beam splitter and obtain an image corresponding to the second image; and comparing at least a portion of the second image to the first image.

In some examples the auxiliary image sensor may be configured to obtain a portion of the second image. The auxiliary image sensor may be configured to obtain a central portion of the second image.

In some examples the method may further comprise comparing a first image captured by a main image sensor with a second image captured by the auxiliary image sensor and adjusting the first image provided to the electronic viewfinder.

In some examples the method may further comprise using a plurality of auxiliary image sensors to obtain a plurality of portions of an image.

In some examples the method may further comprise using a pellicle mirror to split the beam from the second optical arrangement.

In some examples the method may further comprise using one or more optical components to compensate for light lost by the beam splitter.

In some examples the first optical arrangement and the second optical arrangement may be configured so that at least a portion of the second image can be displayed overlaying the first image.

In some examples the first optical arrangement and the second optical arrangement may be configured so that the first image can be displayed adjacent to the second image.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only to the accompanying drawings in which:

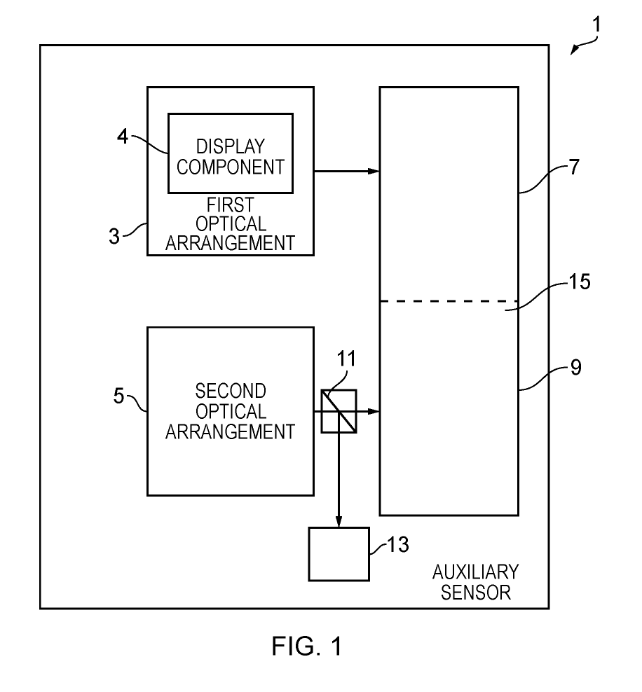

FIG. 1 illustrates an apparatus;

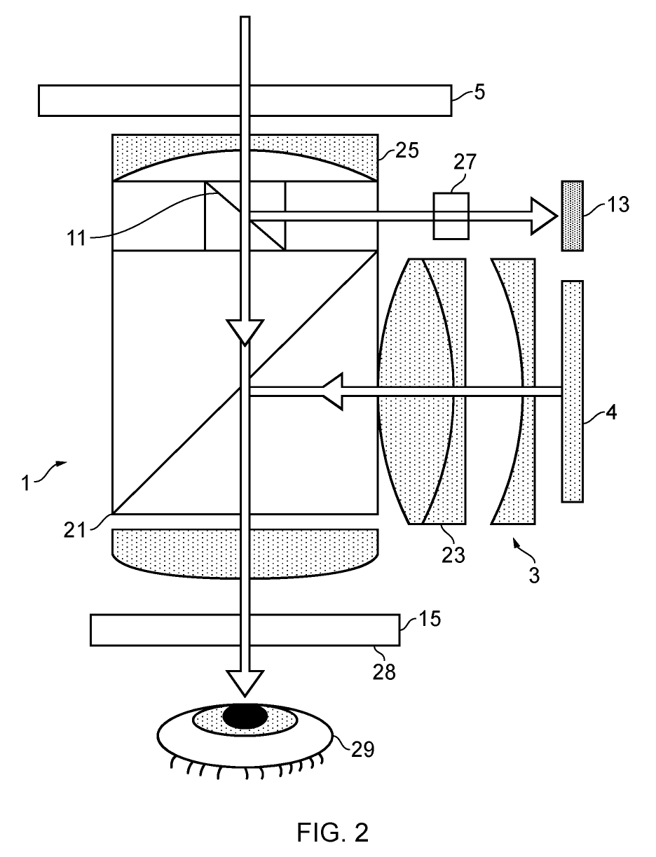

FIG. 2 illustrates an apparatus;

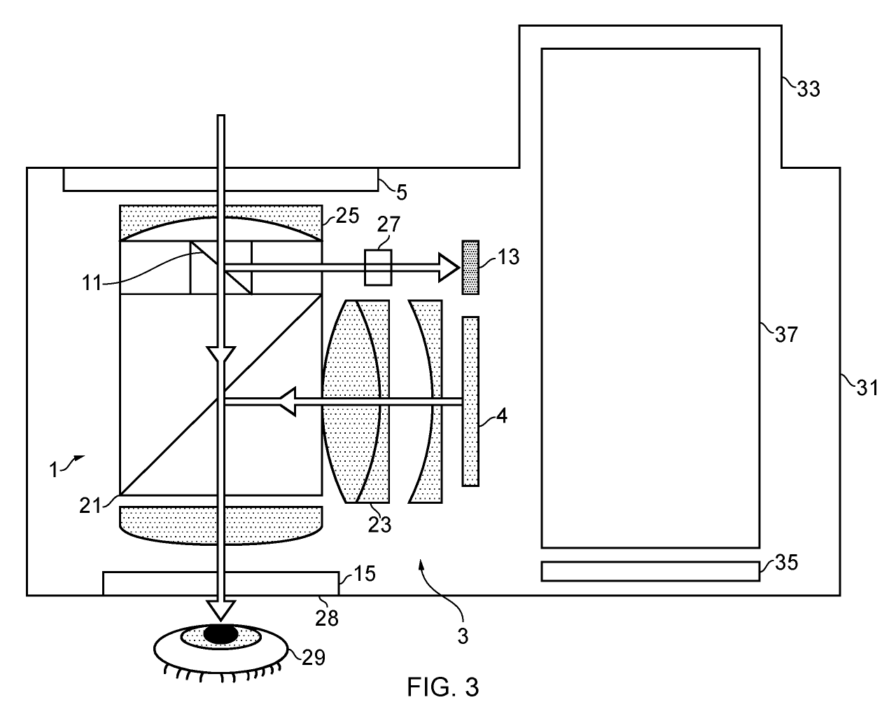

FIG. 3 illustrates a camera comprising an apparatus;

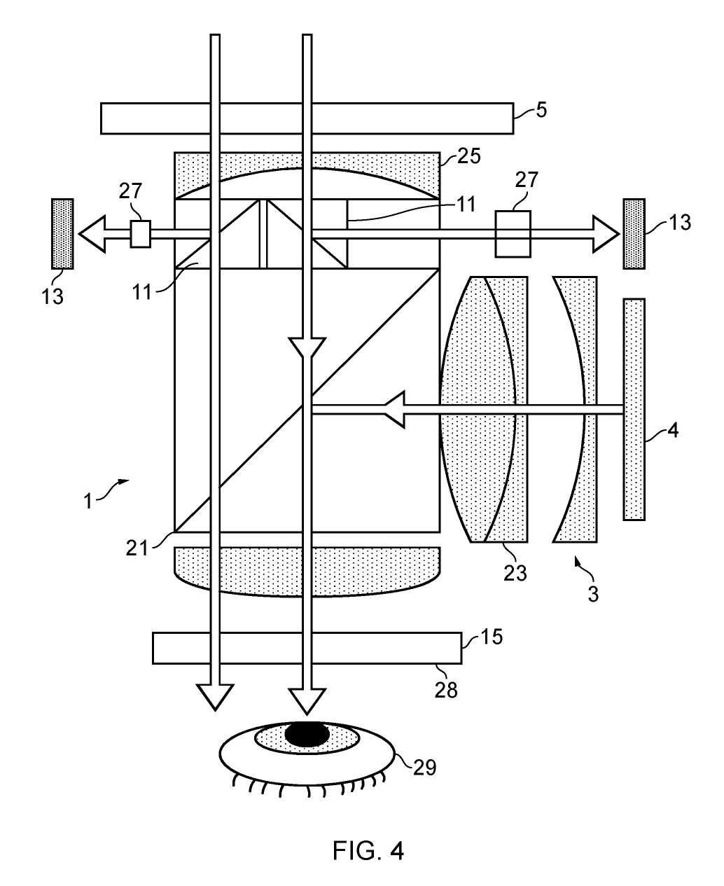

FIG. 4 illustrates an apparatus;

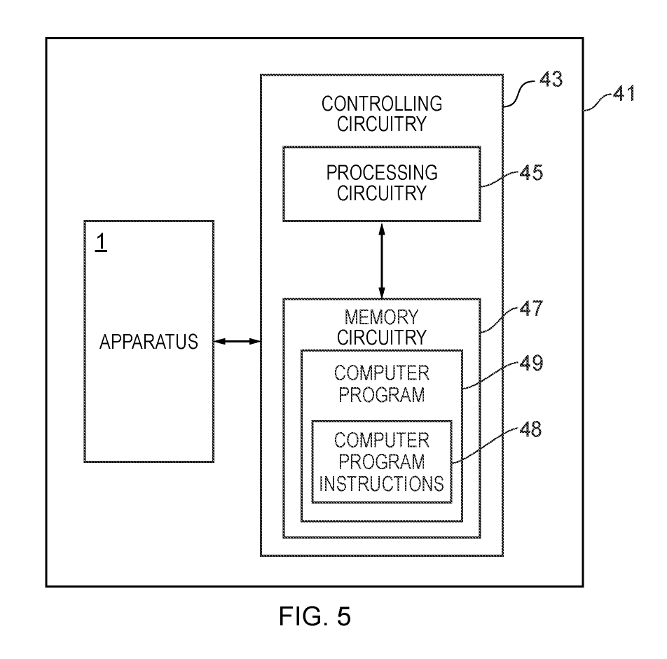

FIG. 5 illustrates an electronic device; and

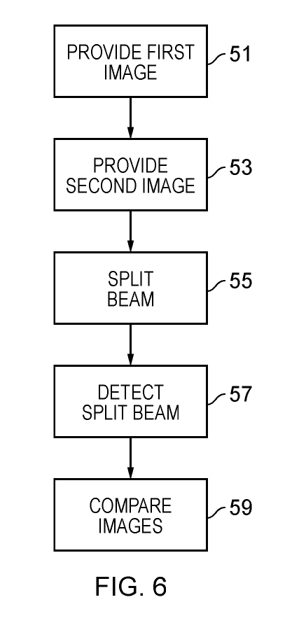

FIG. 6 illustrates a method.

### DETAILED DESCRIPTION

The Figures illustrate an apparatus 1 and method. In the examples the apparatus 1 comprises: a first optical arrangement 3 configured to provide a first image to an electronic viewfinder 7 wherein the first optical arrangement 3 comprises a display component 4; a second optical arrangement 5 configured to provide a second image to an optical viewfinder 9; a beam splitter 11 configured to split a beam from the second optical arrangement 9; and an auxiliary image sensor 13 configured to detect the beam from the beam splitter 11 and obtain an image corresponding to the second image so that at least a portion of the second image can be compared to the first image.

FIGS. 1 to 4 schematically illustrate apparatus 1 according to examples of the disclosure. The apparatus 1 may be for capturing images. The apparatus 1 may be for providing a hybrid viewfinder where the hybrid viewfinder comprises both an optical viewfinder and an electronic viewfinder.

The apparatus 1 schematically illustrated in FIG. 1 comprises, a first optical arrangement 3, a second optical arrangement 5 and a hybrid viewfinder 15. Only features referred to in the following description are illustrated in FIG. 1. However, it should be appreciated that the apparatus 1 may comprise additional features that are not illustrated.

In the schematic example of FIG. 1 the hybrid viewfinder 15 comprises an electronic viewfinder 7 and an optical viewfinder 9. In the hybrid viewfinder 15 the view provided to the user may comprise a first image which may be provided by the electronic viewfinder 7 or a second image which may be provided by the optical viewfinder 9. In some examples the hybrid viewfinder 15 may enable a user to view a combination of the first and second image. For example part of the first image may be provided overlaying the second image. In some examples the first image may be provided adjacent to the second image. This may enable a user to view, at least part of the first and second images simultaneously.

The first optical arrangement 3 may comprise any means which may be configured to provide a first image to the electronic viewfinder 7. The electronic viewfinder 7 may be part of the hybrid viewfinder 15. The first optical arrangement 3 may comprise one or more optical devices such as one or more lenses.

In the example of FIG. 1 the first optical arrangement 3 comprises a display component 4. The display component 4 may comprise any means which may be configured to display an image captured by the main image sensor of an image capturing device such as a camera. The main image sensor 35 may be configured to obtain a through the lens image so that the first image that is provided to the electronic viewfinder 7 corresponds to the image that will be captured by the image capturing device. The first optical arrangement 3 may also comprise any means configured to focus or deflect incident light from the display component 4 to the electronic viewfinder 7.

The display component 4 may comprise any suitable type of display or part of a display. For example the display component 4 may comprise an LCD (liquid crystal display) or any other suitable means.

The second optical arrangement 5 may comprise any means which may be configured to provide a second image to an optical viewfinder 9. The optical viewfinder 9 may be part of the hybrid viewfinder 15. The second optical arrangement 5 may comprise any means configured to focus or deflect incident light from an aperture to the optical viewfinder 9. The second optical arrangement 5 may comprise one or more optical devices such as one or more lenses.

In the schematic example of FIG. 1 the first optical arrangement 3 and the second optical arrangement 5 are shown as separate arrangements. It is to be appreciated that in some examples the first optical arrangement 3 and the second optical arrangement 5 may share one or more optical components.

The second image provided to the optical viewfinder 9 may be different to the image that is captured by the main image sensor and displayed by the display component 4. As the second image is a non-through the lens image there is an inherent parallax between the first image and the second image. This may be confusing for a user of the apparatus 1. If the two images are displayed simultaneously then the user will be presented with two slightly different images which might not be aligned. It may be particularly problematic for a user trying to adjust the focusing point because the actual focusing point, relative to the second image provided by the optical viewfinder 9, is different for different distances to an object being imaged.

In examples of the disclosure the apparatus 1 also comprises a beam splitter 11 and an auxiliary image sensor 13. The beam splitter 11 and the auxiliary image sensor 13 may enable the images provided to the hybrid viewfinder 15 to be adjusted. The beam splitter 11 and the auxiliary image sensor 13 may enable the images provided to the hybrid viewfinder 15 to be adjusted to take the parallax of the optical viewfinder 9 into account.

The beam splitter 11 may comprise any means which may be configured to split a beam into at least two components. In examples of the disclosure the beam splitter 11 is configured to split a beam provided by the second optical arrangement 5. In some examples the beam splitter 11 may be provided separate to the second optical arrangement 5. In other examples the beam splitter 11 may be part of the second optical arrangement 5.

The beam splitter 11 may comprise any suitable optical device such as a pellicle mirror, prism or any other suitable device. The beam splitter 11 may be a small optical device so that the inclusion of the beam splitter 11 into the apparatus 1 does not significantly increase the size of the apparatus 1.

The auxiliary image sensor 13 may comprise any means which may be configured to detect images. The auxiliary image sensor 13 may enable the detected images to be stored in memory circuitry. The auxiliary image sensor 13 may comprise any suitable type of image sensor. For instance the auxiliary image sensor 13 may comprise a digital image sensor such as a charge-coupled-device (CCD) or a complementary metal-oxide-semiconductor (CMOS). In some examples the auxiliary image sensor 13 may comprise the same type of image sensor as the main image sensor.

The auxiliary image sensor 13 may be configured to detect a beam from the beam splitter 11. This enables the auxiliary image sensor 13 to obtain an image corresponding to the second image which is provided to the optical viewfinder 9. This enables the auxiliary image sensor 13 to obtain a non-through the lens image. The image obtained by the auxiliary image sensor 13 will be different to the image obtained by the main image sensor and displayed on the display component 4.

In some examples the auxiliary image sensor 13 may be smaller than the main image sensor. In such examples the auxiliary image sensor 13 may be configured to obtain an image corresponding to a portion of the second image. In some examples the auxiliary image sensor 13 may be configured to obtain an image corresponding to a central portion of the second image. In other examples the auxiliary image sensor 13 may detect other parts of the second image.

In examples of the disclosure the second image, or portion of the second image, that is obtained by the auxiliary image sensor 13 may be compared to the first image that is obtained by the main image sensor and displayed on the display component 4. The images may be provided to controlling circuitry to enable the images to be analyzed and compared. The controlling circuitry may be configured to identify differences such as misalignment between the first image and the second image. The controlling circuitry may also be configured to adjust the images which are provided to the hybrid viewfinder 15 so that the user does not view the differences in the two images. This may reduce confusion for the user and may make it easier for a user to focus the image capturing apparatus. This may also enable perfect alignment of the first image and the second image, this may allow parts of the images to be displayed overlaying each other and may enable other features and functions which may make use of the alignment of the two images.

FIG. 2 schematically illustrates another apparatus 1 according to examples of the disclosure. The example apparatus 1 of FIG. 2 also comprises a first optical arrangement 3, a second optical arrangement 5, a hybrid viewfinder 15 a beam splitter 11 and an auxiliary image sensor 13. These components may be as described above. Corresponding reference numerals are used for corresponding features. It is also to be appreciated that the apparatus 1 may comprise additional features, such as additional optical devices, that are not illustrated in FIG. 2 for simplicity.

The hybrid view finder 15 comprises an optical component 28 such as a lens or other glass portion that the user can look through to view the images obtained by the hybrid view finder 15. To use the hybrid viewfinder the user positions their eye 29 adjacent to the optical component 28.

In the example of FIG. 2 the first optical arrangement 3 comprises a display component 4 and a plurality of optical devices 23. The optical devices 23 may comprise lenses or any other suitable devices. The second optical arrangement 5 also comprises a plurality of optical devices 25 such as lenses. In some examples the second optical arrangement 5 may comprise one or more lenses 27 provided between the beam splitter 11 and the auxiliary image sensor 13. The second optical arrangement 5 may be configured to focus the second image for the auxiliary image sensor 13 at the same plane/distance as the image captured by the main sensor.

In the example apparatus 1 of FIG. 2 the first optical arrangement 3 is arranged so that the beam provided by the first optical arrangements 3 is provided perpendicular to the beam provided by the second optical arrangement 5. It is to be appreciated that other configurations of the optical arrangements 3, 5 may be used in other examples of the disclosure.

The example apparatus 1 of FIG. 2 also comprises a half mirror 21. The half mirror 21 is configured to pass and reflect light. In the example of FIG. 2 the half mirror 21 is configured to pass light from the second optical arrangement 5 to enable a second image to be provided to the hybrid viewfinder 15. The half mirror 21 is also configured to reflect light from the first optical arrangement 3 to enable a first image to be provided from the display component 4 to the hybrid viewfinder 15.

The example apparatus 1 of FIG. 2 may be configured such that the first image, and/or information from the first image, may be provided overlaying the second image. In such examples the hybrid viewfinder 15 comprises an electronic viewfinder 7 overlaying the optical viewfinder 9. In such examples part of the second image may be blocked to allow the first image, or part of the first image, to be displayed.

In some examples the apparatus 1 may be arranged to block the beam from the second optical arrangement 5 so that an electronic viewfinder 7 is provided. For instance a curtain or shutter may be positioned to block light from the second optical arrangement 5 so that only the beam from the display component 4 is provided to the optical component 28. Alternatively the apparatus 1 may be arranged to block the beam from the first optical arrangement 3 so that an optical viewfinder 9 is provided. This may be achieved by blocking the beam from the display component 4 or switching the display component off so that no beam is provided by the display component 4. This may enable a user to view just the first image or just the second image. The apparatus 1 may be arranged to enable a user to switch between the different views. In some examples the apparatus 1 may also comprise means for combining the two beams.

The beam splitter 11 is provided between the second optical arrangement 5 and the half mirror 21. In the example of FIG. 2 the auxiliary image sensor 13 is configured to obtain a central portion of the second image. The central portion may comprise the focusing point of the optical viewfinder 9 and an area around the focusing point.

Once the auxiliary image sensor 13 has detected the second image, the second image, or at least a portion of the second image, can be compared to the first image. Any suitable technique, such as image recognition algorithms, may be used to identify the part of the first image which corresponds to the portion of the second image which has been captured by the auxiliary image sensor 13. Once the corresponding parts of the two images have been identified differences and any misalignments between the two images can be determined. The first image may then be adjusted to take into account the identified the differences and any misalignments. This enables the first image and the second image to be aligned. This enables a user to select a focus point for the main image sensor based on the view seen through the optical viewfinder 9. It also allows for a better combination of the images from the optical viewfinder 9 and the electronic viewfinder 7.

In examples of the disclosure the first image may be adjusted. The first image may be adjusted by modifying the position and size of the first image or at least a portion of the first image.

In some examples the first image that is displayed in the hybrid viewfinder 15 may be modified, however no modifications or adjustments might be made to the image that is captured and stored by the main image sensor 35. In some examples there may also be modifications made to the image that is stored by the main image sensor 35. For example a pre-cropped image may be saved in addition to a whole image. This may be useful when the first image is wider and/or taller than the second image.

In some examples metadata may be stored with the image from the main image sensor 35. The metadata could comprise an image from the optical viewfinder 9, information relating to a calculated offset or other differences between the first image and the second image or any other suitable information.

FIG. 3 illustrates a camera 31 comprising an apparatus 1 as described above. The camera 31 comprises a hybrid view finder 15 which may be as described above. Corresponding reference numerals are used for corresponding features. The camera 31 also comprises a main image sensor 35 and a main optical arrangement 37.

The main image sensor 35 may be configured to detect images and enable the detected images to be stored in memory circuitry. The main image sensor 35 may be configured to obtain a through the lens image and provide the image to the display component 4 so that the first image that is provided to the electronic viewfinder 7 corresponds to the image that will be captured by the camera 31.

The main image sensor 35 may comprise any suitable type of image sensor. The main image sensor 35 may comprise any means which is configured to convert light incident on the main image sensor 35 into an electrical signal to enable an image to be produced. The main image sensor 35 may comprise, for example, a digital image sensor such as a charge-coupled-device (CCD) or a complementary metal-oxide-semiconductor (CMOS).

The main optical arrangement 37 may comprise any means configured to focus or deflect incident light from an aperture to the main image sensor 35. The main optical arrangement 37 may comprise one or more optical devices such as one or more lenses. In the example of FIG. 3 at least some of the optical devices of the main optical arrangement 37 are provided in the lens barrel 33 of the camera 31 and at least some of the optical devices of the main optical arrangement 37 are provided within the body of the camera 31. It is to be appreciated that in other examples other arrangements may be provided. For instance, in some examples, all of the main optical arrangement 37 could be provided within the lens barrel 33. In such examples the optical arrangement 37 could comprise interchangeable lenses.

In the example of FIGS. 2 and 3 the auxiliary image sensor 13 may be configured to capture the central portion of the second image as this may correspond to the main focus points of the images. The central portion may also be sufficient to provide a reference point. In other examples additional reference points may be useful. In such examples a plurality of auxiliary image sensors 13 may be provided to enable a plurality of different portions of the second image to be captured. FIG. 4 schematically illustrates an example apparatus 1 which comprises a plurality of beam splitters and a plurality of auxiliary image sensors 13.

FIG. 4 schematically illustrates another apparatus 1 according to examples of the disclosure. The example apparatus of FIG. 4 is similar to the apparatus 1 of FIG. 2 except that the apparatus 1 in FIG. 4 comprises a plurality of beam splitters 11 and auxiliary image sensors 13.

In the particular example of FIG. 4 the apparatus 1 comprises two auxiliary image sensors 13. It is to be appreciated that any number of auxiliary image sensors 13 may be provided in other examples of the disclosure.

In the example of FIG. 4 the different auxiliary image sensors 13 may be configured to detect different parts of the second image. This may provide more reference points for the comparison and adjustment of the images. The images captured by the additional auxiliary image sensors 13 may also be used for additional purposes such as determining where the edge of first image is compared to the second image, determining light levels and enabling adjustments for variations in light sources or any other suitable purposes.

In the example of FIG. 4 the two beam splitters 11 are provided adjacent to each other. In other examples the beam splitters 11 may be provided in different arrangements and configurations.

In the example of FIG. 4 the second optical arrangement 5 may comprise one or more lenses 27 provided between each of the beam splitters 11 and the corresponding auxiliary image sensor 13. Other optical arrangements may be used in other examples of the disclosure.

FIG. 5 schematically illustrates an electronic device 41. The electronic device 41 may be an image capturing device such as a digital camera or any other suitable device. The electronic device 41 may comprise an apparatus 1 as described above with reference to any of FIGS. 1 to 4. The electronic device 41 also comprises controlling circuitry 43.

The controlling circuitry 43 and apparatus 1 may be operationally coupled. It is to be appreciated that any number or combination of intervening elements may be provided between the controlling circuitry 43 and the apparatus 1 including no intervening elements.

In the illustrated example the controlling circuitry 43 comprises processing circuitry 45 and memory circuitry 47. The controlling circuitry 43 provides means for controlling the electronic device 41. The controlling circuitry 43 may be implemented using instructions that enable hardware functionality, for example, by using executable computer program instructions 48 in general-purpose or special-purpose processing circuitry 45 that may be stored on a computer readable storage medium (e.g. disk, memory etc) to be executed by such processing circuitry 45.

The controlling circuitry 43 may be configured to control the electronic device 41 to perform a plurality of different functions. For example the controlling circuitry 43 may be configured to control the electronic device 41 to capture and store images. In some embodiments of the disclosure the controlling circuitry 43 may also be configured to perform image processing on the captured images. The controlling circuitry 43 may be configured to perform image processing. For example, the controlling circuitry 43 may be configured to compare a first image captured by the main image sensor 35 and the second image captured by the auxiliary image sensor 13 and adjust the images as described above.

The memory circuitry 47 may be configured to store a computer program 49 comprising computer program instructions 48 that control the operation of the electronic device 41 when loaded into the processing circuitry 45. The computer program instructions 48 provide the logic and routines that enable the apparatus 1 to perform at least some of the methods illustrated in FIG. 6 and described below. The processing circuitry 45 by reading the memory circuitry 47 is able to load and execute the computer program 49.

The computer program 49 may arrive at the electronic device 41 via any suitable delivery mechanism. The delivery mechanism may be, for example, a computer-readable storage medium, a computer program product, a memory device, a record medium such as a CD-ROM or DVD, or an article of manufacture that tangibly embodies the computer program. The delivery mechanism may be a signal configured to reliably transfer the computer program 49. The electronic device 41 may propagate or transmit the computer program 49 as a computer data signal.

Although the memory circuitry 47 is illustrated as a single component in the figures it is to be appreciated that it may be implemented as one or more separate components some or all of which may be integrated/removable and/or may provide permanent/semi-permanent/dynamic/cached storage.

Although the processing circuitry 45 is illustrated as a single component in the figures it is to be appreciated that it may be implemented as one or more separate components some or all of which may be integrated/removable.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 6 illustrates an example method. The method may be performed using apparatus 1 and electronic devices 41 as described above. The method comprises, at block 51, using a first optical arrangement 3 to provide a first image to an electronic viewfinder 7 wherein the first optical arrangement 5 comprises a display component 4. The method also comprises, at block 53, using a second optical arrangement to provide a second image to an optical viewfinder 9. At block 55 the method comprises splitting a beam from the second optical arrangement 5 and at block 57 the method comprises using an auxiliary image sensor 13 to detect the beam from the beam splitter 11 and obtain an image corresponding to the second image. At block 59 the method comprises comparing at least a portion of the second image to the first image.

Examples of the disclosure enable an image obtained using an optical viewfinder 9 to be compared to an image obtained using an electronic viewfinder 7. The two images can be then be aligned computationally. This may enable the focus point of the main image sensor 35 may be selected based on the view seen through the optical viewfinder 9. It may also enable overlapping optical viewfinder 9 and electronic viewfinder views 7 which may require alignment of the two images to be provided.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this detailed description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a first optical arrangement configured to provide a first image to an electronic viewfinder wherein the first optical arrangement comprises a display component;
a second optical arrangement configured to provide a second image to an optical viewfinder;
a beam splitter configured to split a beam from the second optical arrangement; and an auxiliary image sensor configured to detect a beam from the beam splitter and obtain an image corresponding to the second image so that at least a portion of the second image can be compared to the first image.

2. An apparatus as claimed in claim 1 wherein the auxiliary image sensor is configured to obtain a portion of the second image.

3. An apparatus as claimed in claim 2 wherein the auxiliary image sensor is configured to obtain a central portion of the second image.

4. An apparatus as claimed in claim 1 wherein the apparatus further comprises image processing circuitry wherein the image processing circuitry is configured to compare a first image captured by a main image sensor with a second image captured by the auxiliary image sensor and adjust the first image provided to the electronic viewfinder.

5. An apparatus as claimed in claim 1 further comprising a plurality of beam splitters and a plurality of auxiliary image sensors.

6. An apparatus as claimed in claim 1 wherein the beam splitter comprises a pellicle mirror.

7. An apparatus as claimed in claim 1 further comprising one or more optical components configured to compensate for light lost by the beam splitter.

8. An apparatus as claimed in claim 1 wherein the first optical arrangement and the second optical arrangement are configured so that at least a portion of the second image can be displayed overlaying the first image.

9. An apparatus as claimed in claim 1 wherein the first optical arrangement and the second optical arrangement are configured so that the first image can be displayed adjacent to the second image.

10. A digital camera comprising an apparatus as claimed in claim 1.

11. A method comprising:
using a first optical arrangement to provide a first image to an electronic viewfinder wherein the first optical arrangement comprises a display component;
using a second optical arrangement to provide a second image to an optical viewfinder;
splitting a beam from the second optical arrangement;
using an auxiliary image sensor to detect the beam from the beam splitter and obtain an image corresponding to the second image; and
comparing at least a portion of the second image to the first image.

12. A method as claimed in claim 11 wherein the auxiliary image sensor is configured to obtain a portion of the second image.

13. A method as claimed in claim 12 wherein the auxiliary image sensor is configured to obtain a central portion of the second image.

14. A method as claimed in claim 11 further comprising comparing a first image captured by a main image sensor with a second image captured by the auxiliary image sensor and adjusting the first image provided to the electronic viewfinder.

15. A method as claimed in claim 11 further comprising using a plurality of auxiliary image sensors to obtain a plurality of portions of an image.

16. A method as claimed in claim 11 further comprising using a pellicle mirror to split the beam from the second optical arrangement.

17. A method as claimed in claim 11 further comprising using one or more optical components to compensate for light lost by the beam splitter.

18. A method as claimed in claim 11 wherein the first optical arrangement and the second optical arrangement are configured so that at least a portion of the second image can be displayed overlaying the first image.

19. A method as claimed in claim 11 wherein the first optical arrangement and the second optical arrangement are configured so that the first image can be displayed adjacent to the second image.
